(19) United States
(12) Patent Application Publication
(10) Pub. No.: US 2007/0166014 A1
(43) Pub. Date: Jul. 19, 2007

(54) Method and system of reducing data storage consumption when storing and using DVD data streams

(76) Inventor: Eyal Schwarzmann, Haifa (IL)

Correspondence Address: MCANDREWS HELD & MALLOY, LTD, 500 WEST MADISON STREET, SUITE 3400, CHICAGO, IL, 60661, US

(21) Appl. No.: 11/333,721

(22) Filed: Jan. 17, 2006

(51) Int. Cl. H04N 5/00

(52) U.S. Cl. 386/125

(57) ABSTRACT

Herein described is a system and method for storing and retrieving DVD data using a data storage drive. The system and method may be employed within an enhanced multimedia processing system, such as a personal video recorder (PVR) or digital video recorder (DVR). The PVR or DVR may incorporate a DVD player/recorder and the data storage drive. The system employs a data processing unit that comprises a digital circuitry and a processor. The digital circuitry may comprise a memory that is used to store software. When executed by the processor, the software implements a removal of non-essential data prior to storing a pack into the data storage drive. When storing the pack into the data storage drive, the method comprises determining a padding packet length of a pack and removing a non-essential padding packet based on said padding packet length.

### BACKGROUND OF THE INVENTION

When a personal video recorder (PVR) or digital video recorder (DVR) receives multimedia data from a telecommunications operator, the multimedia data may be stored within a data storage drive. The data storage drive may comprise a hard disk drive within the PVR or DVR. Given the maximum storage capacity provided by such a hard disk drive, maximizing the amount of data that may be stored within the hard disk drive is of great importance.

The limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention provide at least a system and a method to efficiently store and retrieve DVD data streams. The various aspects of the invention are substantially shown in and/or described in connection with at least one of the following figures, as set forth more completely in the claims.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1 is a block diagram of an enhanced multimedia processing system that maximizes the storage functionality provided by a data storage device when storing and retrieving DVD data streams, in accordance with an embodiment of the invention.

FIG. 2 is a block diagram of a data processing unit that is used for storing and retrieving DVD data streams, in accordance with an embodiment of the invention.

FIG. 3 is a block diagram that describes the structure of a representative pack that is used by the invention.

FIG. 4 is an operational flow diagram describing the storage of one or more packs into a data storage drive, in accordance with an embodiment of the invention.

FIG. 5 is an operational flow diagram describing the retrieval of one or more packs from a data storage drive, in accordance with an embodiment of the invention.

### DETAILED DESCRIPTION OF THE INVENTION

Various aspects of the invention provide at least a system and a method to improve the utilization of storage space provided by a data storage drive when using DVD (digital video disc) data streams. The various aspects of the invention allow for a more efficient method of storing and retrieving DVD ready data streams using the data storage drive. In a representative embodiment, the DVD ready data streams are received by a personal video recorder (PVR) and stored in a data storage drive residing within the personal video recorder (PVR). In a representative embodiment, the data storage drive may comprise a magnetic hard disk drive, for example. By using the system and method, less storage capacity is used to store a DVD ready data stream. As a result, additional storage capacity is generated in the data storage drive. In a representative embodiment, the DVR or PVR may comprise a DVD player/recorder that is used to read or write data onto a DVD. By way of utilizing or implementing the various aspects of the invention, the amount of data that is capable of being stored into the data storage drive is increased.

Aspects of the invention allow for the removal of redundant or “non-essential” data from a DVD data stream before it is stored into a data storage drive of a DVR or PVR. Because the redundant or “non-essential” data is removed, the data storage drive is provided with additional capacity. In a representative embodiment, the “non-essential” data is termed a “padding packet” or “packet for padding” as may be referenced in Section 5.2.1 of the DVD Specifications for Read-Only Disc, Part 3 Video Specifications (Version 1.0, dated August 1996). A “padding packet” may be found within a pack of a VOB (video object) of a VOBS (video object set) in a DVD data stream. The pack may comprise an audio pack, for example. The structure of such a pack may comply with MPEG-2 standard 13818-1. Furthermore, the various aspects of the invention provide for reinsertion of the “non-essential” data when a DVD is to be burned using a DVD player/recorder. The DVD player/recorder may reside within the DVR or PVR. The format and structure of DVD data is specified in the DVD Specifications for Read-Only Disc, Part 3 Video Specifications (Version 1.0, dated August 1996), which is hereby incorporated by reference in its entirety.

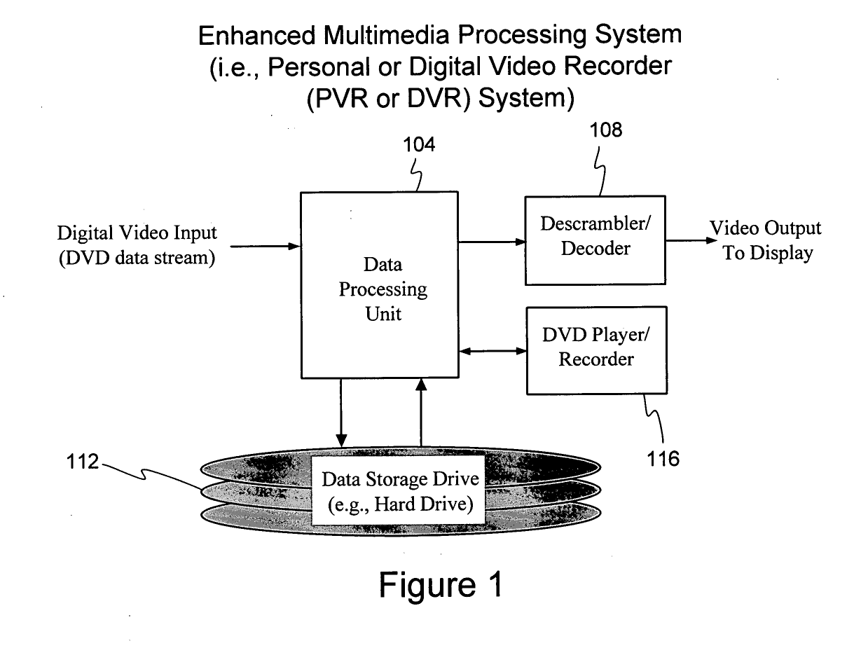

FIG. 1 is a block diagram of an enhanced multimedia processing system that maximizes the storage functionality provided by a data storage device when storing and retrieving DVD data streams, in accordance with an embodiment of the invention. The enhanced multimedia processing system may comprise an exemplary personal video recorder (PVR) or digital video recorder (DVR), as indicated in FIG. 1. The enhanced multimedia processing system (EMPS) comprises a data processing unit 104, a descrambler/decoder 108, a data storage drive 112, and a DVD player/recorder 116. The data processing unit 104 receives and processes a digital video data stream. In a representative embodiment, the data processing unit 104 receives a DVD data stream. Although not shown, an encoder and/or transcoder residing within the PVR or DVR may generate the DVD data stream. The DVD data stream may be generated from a received analog video signal, for example. The analog video signal may be supplied by a telecommunications carrier, for example. One or more video programs or channels may be transmitted to the DVR or PVR from the telecommunication services provider. The data processing unit 104 may process a pack such that a padding packet, as was previously discussed, may be removed or omitted from the pack before being stored into the data storage drive 112. As may be referenced in the DVD Specifications for Read-Only Disc, a padding packet comprises extra data (bytes) that are used to fill a pack in order to obtain a particular pack size. The pack length, as specified in the DVD Specifications for Read-Only Disc, is 2048 bytes. The data processing unit may comprise circuitry and software that is used for removing padding packets. After the padding packets are removed, the resulting data is subsequently stored into the data storage drive 112. Consequently, less storage space is used when one or more packs (minus their associated padding packets) are stored into the data storage drive 112. The gain in storage space may be used for increasing the duration or for improving the quality of the multimedia program being stored. Hence, as a result of utilizing one or more aspects of the invention, the data storage drive 112 may provide increased storage for DVD data. The data storage drive 112 may comprise an exemplary magnetic hard disk drive, optical disk drive, or any other like storage drive. On the other hand, the data processing unit 104 may be used for reinserting any previously removed padding packets. The data processing unit 104 may insert padding packets as necessary, for example, before writing the DVD data onto a DVD using the DVD player/recorder 116. The data processing unit 104 may insert padding packets when video is played to a user using a DVD player, for example. The descrambler/decoder 108 may be used to decode and/or descramble the DVD data that is provided to a display.

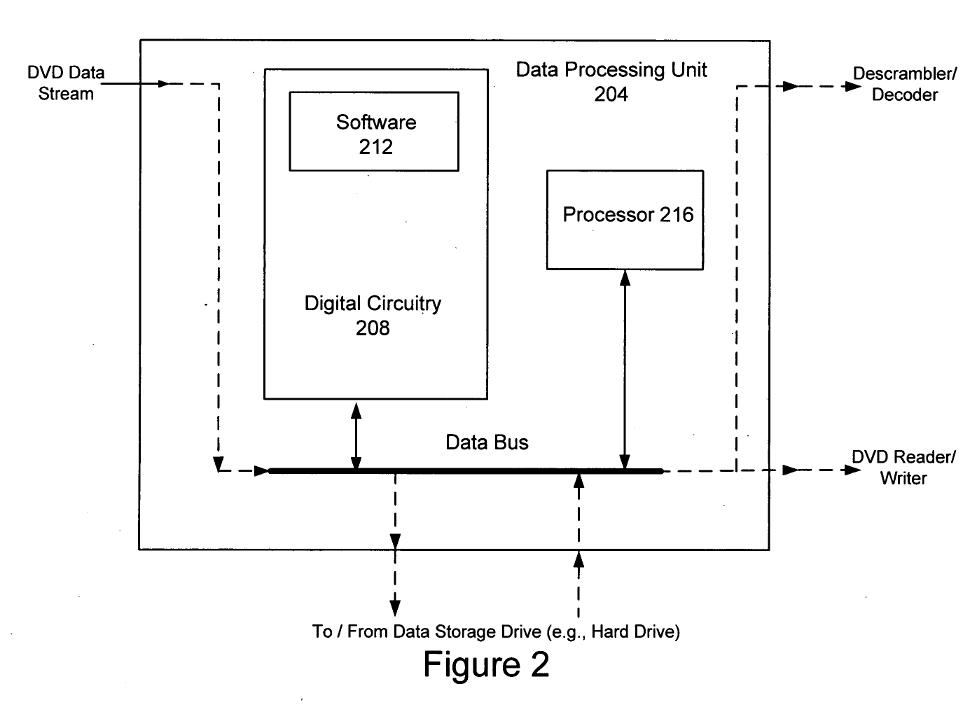

FIG. 2 is a block diagram of a data processing unit 204 that is used for storing and retrieving DVD data streams, in accordance with an embodiment of the invention. The data processing unit 204 may correspond to the data processing unit described in FIG. 1. As illustrated, the data processing unit 204 comprises a digital circuitry 208 and a processor 216. The processor 216 and the digital circuitry 208 communicate by way of a data bus. The data bus is used to provide a conductive communication pathway for data transfer between components within the data processing unit 204. The data processing unit 204 processes a DVD data stream by executing software 212 stored in the digital circuitry 208. The digital circuitry 208 may comprise a memory, such as a flash memory or NVRAM capable of storing the software 212 necessary for performing removal and reinsertion of padding packets. The processor 216 may execute the software 212 when a user instructs a PVR or DVR to store a selection into its data storage drive. A DVD data stream is received and transmitted throughout the data processing unit 204 by way of the data bus. The data processing unit 204 outputs data to a descrambler/decoder and a DVD player/recorder. The descrambler/decoder may be used to decode and/or descramble the data that is provided to the display while the DVD player/recorder may be used to burn a copy of a DVD that complies with the DVD Specifications for Read-Only Disc. The data processing unit 204 may be used to reinsert a padding packet into a pack, prior to transmitting the pack to the DVD player/recorder or the descrambler/decoder, such that the data written onto the DVD conforms to the DVD Specifications for Read-Only Disc. The processor 216 is capable of executing commands and/or instructions provided by the software. When executed, the software implements and/or provides the functionality to facilitate the removal and reinsertion of padding packets. It is contemplated that the functions implemented by the software may also be implemented using hardware. The hardware may comprise a circuitry such as an FPGA (field programmable gate array), for example.

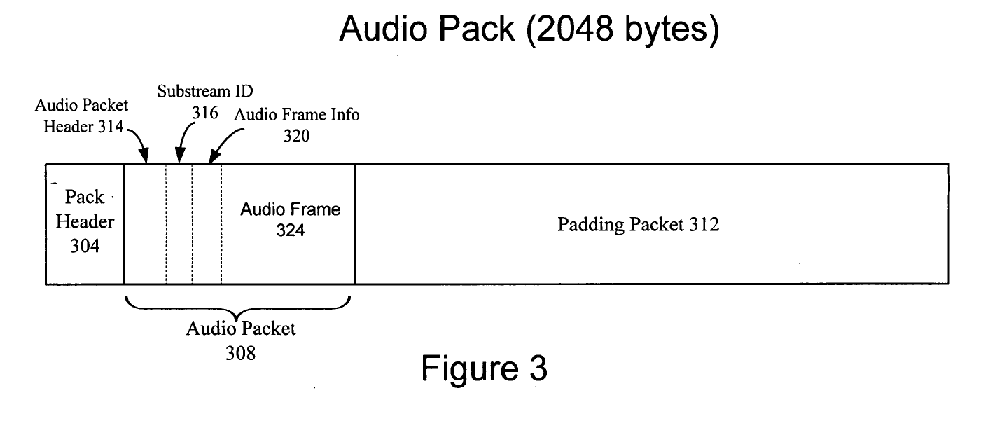

FIG. 3 is a block diagram that describes the structure of a representative pack that is used by the invention. As shown, an audio pack has length 2048 bytes and comprises a pack header 304, an audio packet 308, and a padding packet 312. In general, the header 304 is located at the beginning of the audio pack and may vary in length as described in section 5.2.1 (Structure of Pack) of the DVD Specifications for Read-Only Disc. Although FIG. 3 illustrates a single audio packet, one or more data packets may be appended after the pack header 304 in other embodiments. The audio packet 308 comprises an audio packet header 314, a substream ID field 316, an audio frame information field 320, and an audio frame 324. The audio packet header 314, substream ID field 316, and audio frame information field 320 may collectively consume a total of up to 38 bytes, per the DVD Specifications for Read-Only Disc. In a representative embodiment, the audio packet 308 comprises a single audio frame 324. In a representative embodiment, the audio frame 324 has length 512 bytes when audio data is encoded using Dolby AC-3. For example, a Dolby AC-3 encoder encodes each Dolby AC-3 frame using 1536 samples. If a Dolby AC-3 encoder provides an output audio rate of 128 kbps (16 k bytes per second) while input samples arrive at 48,000 times per second, the encoder processes frames at 31.25 frames per second. By computing the quotient of the output audio rate (16 k bytes per second) and the frame rate (31.25 frames per second), the value 512 bytes per frame is obtained. As a consequence, up to 1536 bytes (2048−512=1536) may be used by the padding packet 312 (if one neglects the up to 38 bytes which may be used by the audio packet header 314, a substream ID field 316, and an audio frame information field 320). The padding packet 312 is appended after the audio frame 324, such that a 2048 byte length is maintained. The padding packet 312 comprises the “non-essential” data that was previously described. Additional details regarding the structure of a pack may be found in the DVD Specifications for Read-Only Disc (Part 3 Video Specifications, Version 1.0, dated August 1996).

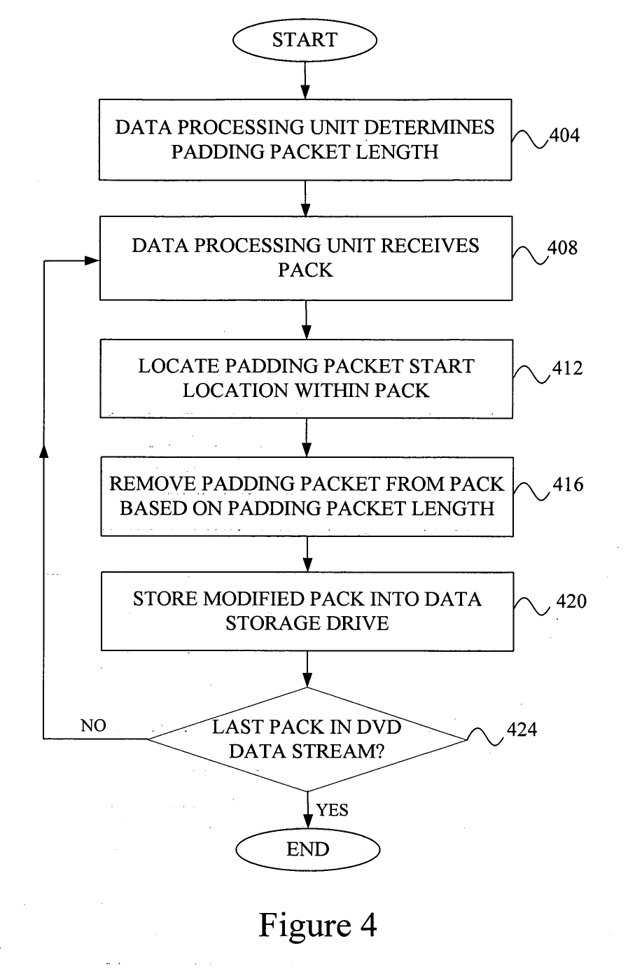

FIG. 4 is an operational flow diagram describing the storage of one or more packs into a data storage drive, in accordance with an embodiment of the invention. The data storage drive may comprise a hard disk drive, for example. In a representative embodiment, the one or more packs may comprise one or more audio packs of a DVD data stream. The DVD data stream may be generated within a PVR (or DVR), for example. For example, an encoder and/or transcoder residing within the PVR or DVR may generate the DVD data stream using a received data signal that is provided by a telecommunications carrier. The received data signal may comprise an analog video signal, for example. The one or more audio packs may comprise Dolby AC-3 audio packs, for example. At step 404, a data processing unit determines the padding packet length of the one or more audio packs to be received. The details of the data processing unit may be referenced in FIG. 2. Next, at step 408, the data processing unit receives the first of one or more packs. The data processing unit may receive the one or more packs from a circuitry that appropriately outputs DVD ready pack data. The DVD data may be output by an encoder or transcoder located within a DVR or PVR, for example. Thereafter, at step 412, the data processing unit locates a padding packet start location within the first pack. Then, at step 416, the padding packet of the first pack is identified based on the padding packet length that was previously determined. The data processing unit subsequently removes the padding packet from the pack. Next, at step 420, the modified pack is subsequently stored in the data storage drive. At step 424, a decision is made whether another pack follows the pack that was previously modified. If the previous pack was not the last pack in the DVD stream, the process reverts back to step 408 at which the data processing unit receives the next pack. Otherwise, the process ends.

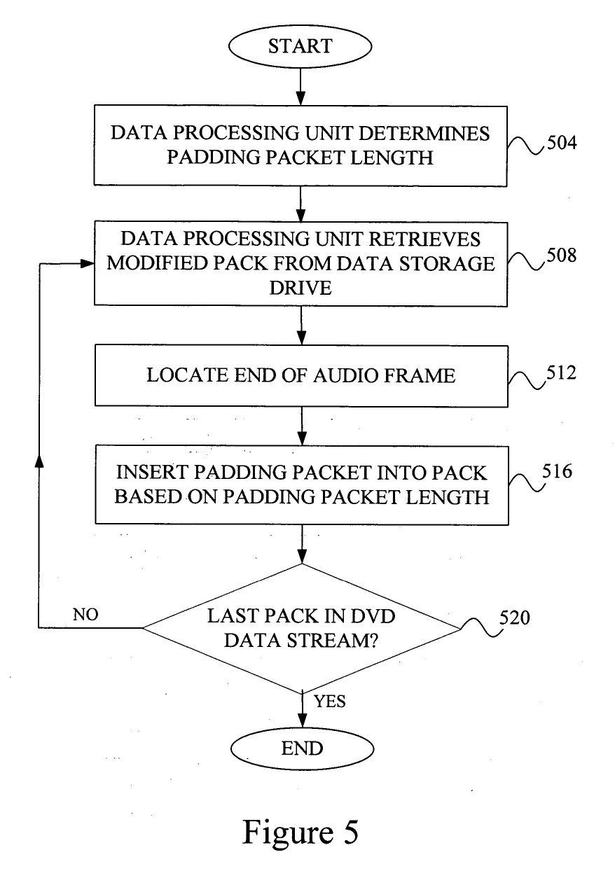

FIG. 5 is an operational flow diagram describing the retrieval of one or more packs from a data storage drive, in accordance with an embodiment of the invention. The retrieval may occur when an integrated DVD player/recorder receives the one or more packs from the data storage drive after one or more padding packets are reinserted into each of the previously modified one or more packs. The retrieval process may occur when a user of a DVR or PVR burns a DVD using the integrated DVD player/recorder, for example. The data storage drive may comprise a hard disk drive, for example. Referring to FIG. 5, the process commences with step 504, at which a data processing unit of an enhanced multimedia processing system (such as a DVR or PVR with an integrated DVD player/recorder, as described in FIG. 1) determines the padding packet length of the padding packet to be inserted into a modified pack. The padding packet length may have been previously determined during the removal process as was previously described in reference to FIG. 4, for example. Thereafter, at step 508, the data processing unit retrieves the first modified pack from the data storage drive. At step 512, the data processing unit locates the end of the audio frame of the first pack. Next, at step 516, the data processing unit appends a padding packet to the end of the audio frame, based on the padding packet length, such that the pack attains a length of 2048 bytes, as specified in the DVD Specifications for Read-Only Disc. Next, at step 520, the data processing unit determines whether there is another modified pack in the DVD data stream that follows the pack that was previously modified. If the previously modified pack is not the last pack in the DVD stream, the process reverts back to step 508 at which the data processing unit receives the next modified pack for processing. Otherwise, the process ends.

The method illustrated in the operational flow diagrams of FIG. 4 and FIG. 5 may be implemented using software represented by the following exemplary pseudo code:

Padding_pack_length = calculate padding length( )
//Remove padding packet before sending data to the hard drive
//this test should be invoked for each pack
If (current_pack=A_PCK)

Remove_padding_packet

//Insert padding packet before displaying DVD data or before burning a
DVD
//This test should be invoked for each Pack
If (current_pack==A_PCK)

Insert_padding_packet (length)

Int Remove_padding_packet( )
{

| | |
|---|---|
| * | Look for next padding start code |
| * | Remove the whole padding packet from the pack, based on the |

“padding_pack_length” variable

| | |
|---|---|
| * | Return OK |

}
Int Insert_padding_pack(length)
{

| | |
|---|---|
| * | Find the end of the audio frame |
| * | Insert padding packet into the pack, based on the |

padding_pack_length

| | |
|---|---|
| * | Return OK |

}

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims that follows.

What is claimed is:

1. A method for storing DVD data into a data storage drive, said method comprising removing padding packets from a pack before said storing is performed.

2. The method of claim 1 wherein said data storage drive comprises a hard disk drive.

3. The method of claim 1 wherein said pack comprises an audio pack.

4. The method of claim 3 wherein said audio pack comprises a Dolby AC-3 audio pack.

5. The method of claim 1 wherein said data storage drive is used within a digital video recorder (DVR) or personal video recorder (PVR).

6. A method for storing and using DVD data in a personal video recorder or digital video recorder comprising:
determining the padding packet length of one or more packs of one or more video object sets (VOBS);
locating the start of said one or more padding packets of said one or more packs;
removing said one or more padding packets from said one or more packs to generate one or more modified packs;
storing said one or more modified packs into a data storage drive;
retrieving said one or more modified packs when required for use by a DVD player/recorder;
locating the end of a frame; and
reinserting said one or more padding packets into said one or more modified packs to regenerate said one or more packs, said removing of said one or more padding packets providing increased storage for storing said DVD data into said data storage drive.

7. The method of claim 6 wherein each of said one or more packs comprises an audio pack.

8. The method of claim 7 wherein said audio pack comprises Dolby AC-3.

9. The method of claim 6 wherein said data storage drive comprises a hard disk drive.

10. The method of claim 6 wherein said pack comprises 2048 bytes.

11. A system for increasing the storage of DVD ready multimedia data into a data storage drive comprising:
a processor; and
a digital circuitry storing a software, said software executed by said processor, said software used for removing one or more padding packets from one or more packs to create one or more modified packs, said removing performed before storing said modified packs into said data storage drive.

12. The system of claim 11 where said software is used for reinserting said one or more padding packets into said one or more modified packs to regenerate said one or more packs.

13. The system of claim 12 wherein said reinserting is performed before reading said one or more packs from said data storage drive using a DVD player.

14. The system of claim 12 wherein said reinserting is performed before writing said one or more packs using a DVD recorder.

15. The system of claim 11 wherein said digital circuitry comprises a flash memory or NVRAM.

16. The system of claim 11 wherein said data storage drive comprises a hard disk drive.

17. The system of claim 11 wherein said pack comprises a length of 2048 bytes.

18. The system of claim 11 wherein said pack comprises an audio pack.

19. The system of claim 18 wherein said audio pack comprises a Dolby AC-3 audio pack.

20. The system of claim 18 wherein said padding packets are appended after an audio frame of said audio pack.
